(19) United States
(12) Patent Application Publication
(10) Pub. No.: US 2017/0048077 A1
(43) Pub. Date: Feb. 16, 2017

(54) INTELLIGENT ELECTRIC APPARATUS AND CONTROLLING METHOD OF SAME

(71) Applicant: Xiaomi Inc., Beijing (CN)

(72) Inventors: Enxing HOU, Beijing (CN); Hong CHEN, Beijing (CN); Deguo MENG, Beijing (CN)

(73) Assignee: Xiaomi Inc.

(21) Appl. No.: 15/214,829

(22) Filed: Jul. 20, 2016

(30) Foreign Application Priority Data
Aug. 13, 2015 (CN) 201510498238.6

(51) Int. Cl. H04L 12/28; H04W 4/02; G05B 19/414; H04W 4/06

(52) U.S. Cl. CPC H04L 12/282; H04W 4/06; H04W 4/023; G05B 19/4147; H04L 2012/2841; H04L 2012/285; G05B 2219/2614

(57) ABSTRACT

The present disclosure relates to an intelligent electric apparatus and a method of controlling the intelligent electric apparatus. The method includes: acquiring a message broadcasted by a smart wearable device; judging whether the smart wearable device is a default smart wearable device in accordance with the message; and controlling a working condition of the intelligent electric apparatus in accordance with a preset parameter if the smart wearable device is determined as the default smart wearable device, the preset parameter including a parameter reflecting a distance between the smart wearable device and the intelligent electric apparatus.

### CROSS-REFERENCE TO RELATED APPLICATIONS

This application is based upon and claims priority to Chinese Patent Application No. 201510498238.6, filed on Aug. 13, 2015, the entire content of which is incorporated herein by reference.

### TECHNICAL FIELD

The present disclosure generally relates to the field of smart home technology and, more particularly, to an intelligent electric apparatus and a method of controlling the intelligent electric apparatus.

### BACKGROUND

At present, smart home is a reflection of internet of things. The smart home provides various functions and means, such as household appliances control, illumination control, telephone remote control, indoor and outdoor remote control, burglar alarm, environment monitoring, HVAC control, infrared transponding and programmable timing control, by means of connecting various devices (such as an air conditioner, an audio-video device, an illuminating system, a curtain controller, a security and protection system, a digital cinema system, a video server, a videos system, a network household appliance, etc.) in the home together via the internet. Compared with conventional home, the smart home not only has a traditional resident function, but also has functions like building, network communication, information household appliances and facility automation, thus providing an interaction function of omni-directional information.

### SUMMARY

According to a first aspect of embodiments of the present disclosure, there is provided a method of controlling an intelligent electric apparatus, including: acquiring a message broadcasted by a smart wearable device; judging whether the smart wearable device is a default smart wearable device in accordance with the message; and controlling a working condition of the intelligent electric apparatus in accordance with a preset parameter if the smart wearable device is determined as the default smart wearable device, the preset parameter including a parameter reflecting a distance between the smart wearable device and the intelligent electric apparatus.

According to a second aspect of embodiments of the present disclosure, there is provided an intelligent electric apparatus, including: a processor; and a memory for storing instructions executable by the processor. The processor is configured to: acquire a message broadcasted by a smart wearable device; judge whether the smart wearable device is a default smart wearable device in accordance with the message; and control a working condition of the intelligent electric apparatus in accordance with a preset parameter if the smart wearable device is determined as the default smart wearable device, the preset parameter including a parameter reflecting a distance between the smart wearable device and the intelligent electric apparatus.

According to a third aspect of embodiments of the present disclosure, there is provided a non-transitory computer-readable storage medium having stored therein instructions that, when executed by a processor of a device, cause the device to perform a method of controlling an intelligent electric apparatus. The method includes: acquiring a message broadcasted by a smart wearable device; judging whether the smart wearable device is a default smart wearable device in accordance with the message; and controlling a working condition of the intelligent electric apparatus in accordance with a preset parameter if the smart wearable device is determined as the default smart wearable device, the preset parameter comprising a parameter reflecting a distance between the smart wearable device and the intelligent electric apparatus.

The technical solution provided by embodiments of the present disclosure may have the following advantageous effects. The message broadcasted by the smart wearable device is acquired; whether the smart wearable device is a default smart wearable device is determined in accordance with the message; in the case that the smart wearable device is determined as the default smart wearable device, the working condition of the intelligent electric apparatus is controlled in accordance with a preset parameter, the preset parameter including a parameter reflecting a distance between the smart wearable device and the intelligent electric apparatus. Therefore, the intelligent electric apparatus is controlled in a smart manner in accordance with the distance between the smart wearable device and the intelligent electric apparatus, so that it is not necessary for the user to manually operate the intelligent electric apparatus, thereby improving the user's experience.

It is to be understood that both the foregoing general description and the following detailed description are illustrative and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method of controlling an intelligent electric apparatus according to an illustrative embodiment.

FIG. 2 is a flow chart showing a step in the method of controlling an intelligent electric apparatus according to an illustrative embodiment.

FIG. 3A is a flow chart showing another method of controlling an intelligent electric apparatus according to an illustrative embodiment.

FIG. 3B is a flow chart showing still another method of controlling an intelligent electric apparatus according to an illustrative embodiment.

FIG. 3C is a flow chart showing a further method of controlling an intelligent electric apparatus according to an illustrative embodiment.

FIG. 3D is a flow chart showing a step in the method of controlling an intelligent electric apparatus according to an illustrative embodiment.

FIG. 3E is another flow chart showing a step in the method of controlling an intelligent electric apparatus according to an illustrative embodiment.

FIG. 4A is still another flow chart showing a step in the method of controlling an intelligent electric apparatus according to an illustrative embodiment.

FIG. 4B is a flow chart showing a further method of controlling an intelligent electric apparatus according to an illustrative embodiment.

FIG. 5 is a flow chart showing a method of controlling an intelligent electric apparatus according to an illustrative embodiment.

FIG. 6 is a flow chart showing another method of controlling an intelligent electric apparatus according to an illustrative embodiment.

FIG. 7 is a block diagram illustrating an intelligent electric apparatus according to an illustrative embodiment.

FIG. 8 is a block diagram illustrating a judging module in an intelligent electric apparatus according to an illustrative embodiment.

FIG. 9 is a block diagram illustrating another intelligent electric apparatus according to an illustrative embodiment.

FIG. 10 is a block diagram illustrating a first controlling module in an intelligent electric apparatus according to an illustrative embodiment.

FIG. 11 is another block diagram illustrating a first controlling module in an intelligent electric apparatus according to an illustrative embodiment.

FIG. 12 is a block diagram illustrating a first controlling module in an intelligent electric apparatus according to an illustrative embodiment.

FIG. 13 is a block diagram illustrating still another intelligent electric apparatus according to an illustrative embodiment.

FIG. 14 is a block diagram illustrating a further intelligent electric apparatus according to an illustrative embodiment.

FIG. 15 is a block diagram applicable to an intelligent electric apparatus according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

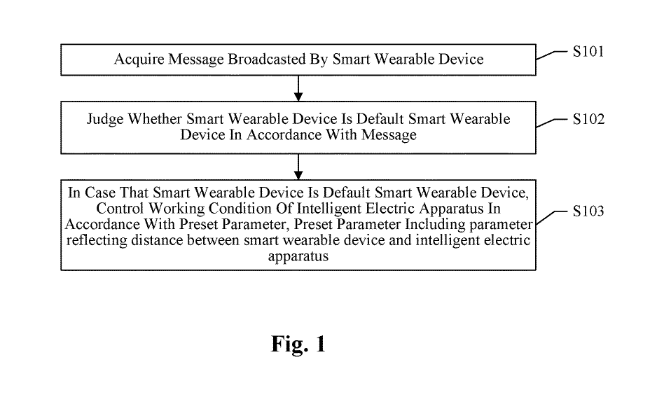

FIG. 1 is a flow chart showing a method of controlling an intelligent electric apparatus according to an illustrative embodiment. Referring to FIG. 1, the method can be applied in the intelligent electric apparatus, or a mobile or fixed terminal, which is not limited herein. The above method includes the following steps S101 to S103.

In step S101, a message broadcasted by a smart wearable device is acquired.

An intelligent electric apparatus employs a wireless communication protocol, such as wireless fidelity (Wi-Fi), BLUETOOTH and ZIGBEE. The intelligent electric apparatus can support multiple communication protocols at the same time, or can at least support the BLUETOOTH protocol. The intelligent electric apparatus can communicate with a terminal used by a user, and receive a local or remote control instruction from a client-side of the terminal. The smart wearable device, such as a smart band and smart glasses, is worn by the user and is employing the BLUETOOTH protocol. The smart wearable device can be paired with or not paired with the intelligent electric apparatus. The smart wearable device periodically broadcasts a wireless message. When the method of the illustrative embodiment is applied in the intelligent electric apparatus, the intelligent electric apparatus receives the message broadcasted by the smart wearable device via Wi-Fi, BLUETOOTH or ZIGBEE. Alternatively, when the method is applied in the terminal used by the user, the terminal used by the user receives the message broadcasted by the smart wearable device via Wi-Fi, BLUETOOTH or ZIGBEE.

In step S102, whether the smart wearable device is a default smart wearable device is judged in accordance with the message.

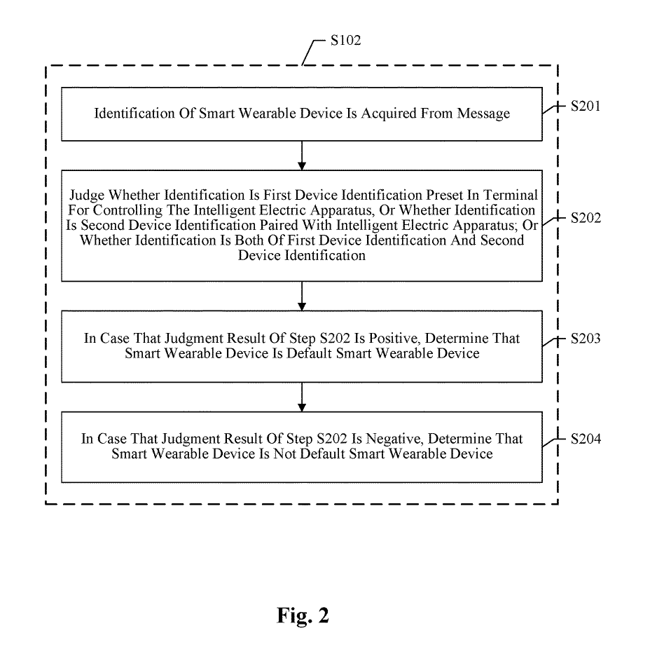

In an embodiment, as shown in FIG. 2, step S102 can be implemented as steps S201 to S204 as described below.

In step S201, an identification of the smart wearable device is acquired from the message broadcasted by the smart wearable device.

The message broadcasted by the smart wearable device includes the identification of the smart wearable device, facilitating other devices to identify the smart wearable device. After receiving the message, the intelligent electric apparatus or the terminal used by the user parses the identification of the smart wearable device in the message. In an embodiment, the identification of the smart wearable device can include a hardware address of the smart wearable device or a unique name of the smart wearable device.

In step S202, it is judged whether the identification is a first device identification preset in the terminal used by the user for controlling the intelligent electric apparatus, or whether the identification is a second device identification paired with the intelligent electric apparatus; or whether the identification is both of the first device identification and the second device. Step S203 is implemented if a judgment result is positive. Step S204 is implemented if the judgment result is negative.

In the current step, the smart wearable device can, via its identification, be paired with the intelligent electric apparatus in advance. Alternatively, the smart wearable device can be not paired with the intelligent electric apparatus, and the terminal used by the user has been set with identifications of devices capable of linking with the smart wearable device. The user can preset the client-side of the terminal to indicate that the smart wearable device is capable of linking with the intelligent electric apparatus.

In step S203, in the case that the judgment result of step S202 is positive, it is determined that the smart wearable device is the default smart wearable device.

In step S204, in the case that the judgment result of step S202 is negative, it is determined that the smart wearable device is not the default smart wearable device.

In the present embodiment, the identification of the smart wearable device is utilized for determining whether the smart wearable device is the default smart wearable device, so as to determine whether the smart wearable device is the default smart wearable device accurately and rapidly.

In step S103, in the case that the smart wearable device is determined as the default smart wearable device, a working condition of the intelligent electric apparatus is controlled in accordance with a preset parameter. The preset parameter includes a parameter reflecting a distance between the smart wearable device and the intelligent electric apparatus.

In an embodiment, there are various types of the preset parameters, such as one or more of the distance between the smart wearable device and the intelligent electric apparatus, and a signal intensity of the message.

In an embodiment, prior to step S103, the method may further include any one or more of steps 301, 302, and 303.

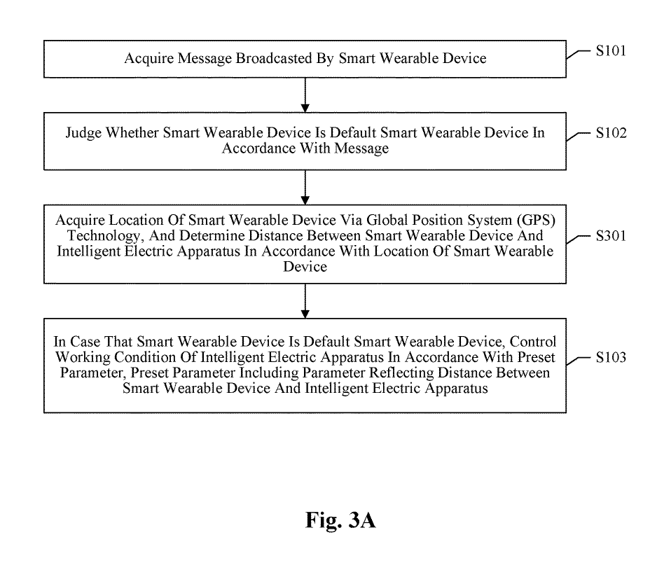

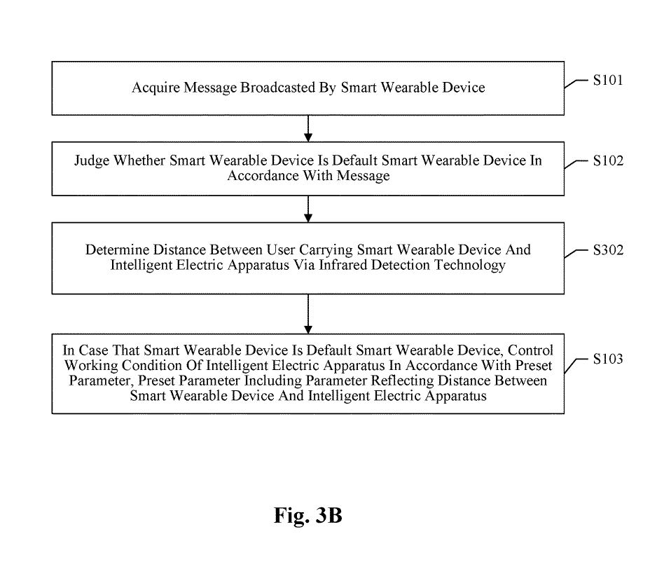

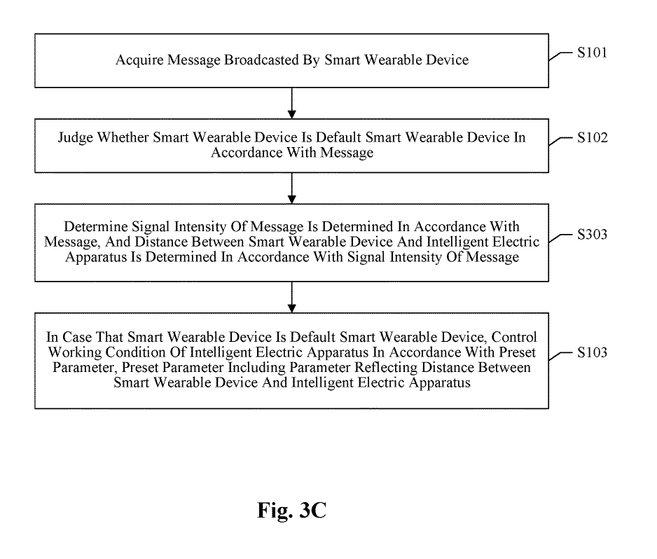

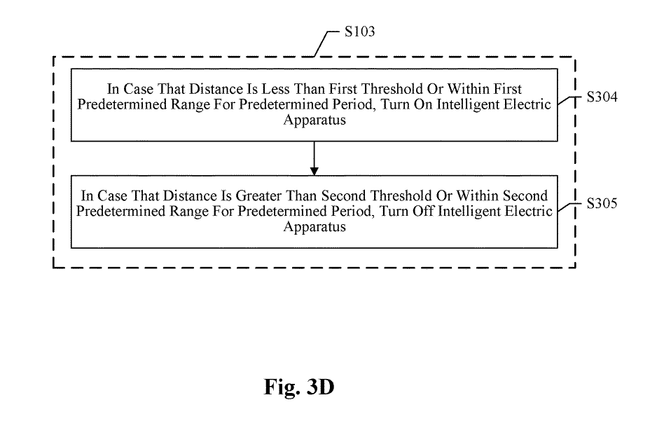

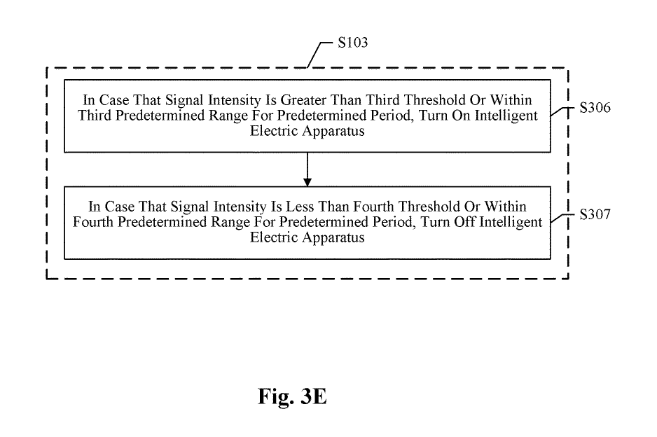

As shown in FIG. 3A, in step S301, a location of the smart wearable device is acquired via a global position system (GPS) technology, and the distance between the smart wearable device and the intelligent electric apparatus is determined in accordance with the location of the smart wearable device.

The GPS technology can locate of the smart wearable device, so as to determine the distance between the smart wearable device and the intelligent electric apparatus conveniently.

As shown in FIG. 3B, in step S302, the distance between the user carrying the smart wearable device and the intelligent electric apparatus is determined via an infrared detection technology.

As shown in FIG. 3C, in step S303, the signal intensity of the message is determined in accordance with the message, and the distance between the smart wearable device and the intelligent electric apparatus is determined in accordance with the signal intensity of the message.

A received signal strength indicator (RSSI) of the message is determined in accordance with the message, and a distance between a signal sending point and a signal receiving point is determined by the received signal intensity. In the present step, the signal sending point is the smart wearable device, and the signal receiving point is the intelligent electric apparatus, such that the distance between the smart wearable device and the intelligent electric apparatus can be determined in accordance with the signal intensity of the message. The stronger the signal intensity is, the shorter the distance between the smart wearable device and the intelligent electric apparatus is; while the poorer the signal intensity is, the longer the distance between the smart wearable device and the intelligent electric apparatus is. The distance between the smart wearable device and the intelligent electric apparatus is determined in accordance with the signal intensity of the message.

As shown in FIGS. 3A, 3B and 3C, step S103 can be implemented after any one of the three steps 301, 302, and 303, or can be implemented after all of, or any two of the three steps. In the case that step S103 is implemented after all of, or any two of the three steps, the order of implementing the steps is not limited.

In an embodiment, as shown in FIG. 3D, in the case that the preset parameter includes the distance between the smart wearable device and the intelligent electric apparatus, step S103 may be implemented as step S304 and/or step S305 as below.

In step S304, in the case that the distance is less than a first threshold or within a first predetermined range for a predetermined period, the intelligent electric apparatus is turned on.

By way of examples, assuming that the first threshold is 3 meters and the predetermined period is 1 minute, in the case that the distance between the smart wearable device and the intelligent electric apparatus is less than 3 meters for 1 minute, as the user is wearing the smart wearable device, it indicates that the user is near the intelligent electric apparatus or is at home. At this time, the intelligent electric apparatus is turned on.

In step S305, in the case that the distance is greater than a second threshold or within a second predetermined range for the predetermined period, the intelligent electric apparatus is turned off.

The first threshold is less than or equal to the second threshold, and a maximal value of the first predetermined range is less than or equal to a minimal value of the second predetermined range.

By way of examples, in the case that the preset parameter is the distance between the smart wearable device and the intelligent electric apparatus, it can be implemented that the second threshold is 6 meters and the predetermined period is 2 minutes. In the case that the distance between the smart wearable device and the intelligent electric apparatus is greater than 6 meters for 2 minute, as the user is wearing the smart wearable device, it indicates that the user is far away from the intelligent electric apparatus or stays away from the home. At this time, the intelligent electric apparatus is turned off.

FIG. 3D shows a circumstance where step S103 includes steps S304 and S305. The order of implementing steps S304 and S305 is not limited to the one shown in FIG. 3D. In addition, in an alternative embodiment, step S103 can include only one of step S304 and step S305.

In an embodiment, as shown in FIG. 3E, in the case that the preset parameter includes the signal intensity of the message, step S103 may also be implemented as step S306 and/or step S307 as below.

In step S306, in the case that the signal intensity is greater than a third threshold or within a third predetermined range for the predetermined period, the intelligent electric apparatus is turned on. In step S307, in the case that the signal intensity is less than a fourth threshold or within a fourth predetermined range for the predetermined period, the intelligent electric apparatus is turned off The third threshold is greater than or equal to the fourth threshold, and a minimal value of the third predetermined range is greater than or equal to a maximal value of the fourth predetermined range.

During specific implementation, the distance between the signal sending point (the smart wearable device) and the signal receiving point (the intelligent electric apparatus) is determined in accordance with the signal intensity of the message received. The signal intensity of the message can be classified into strong and poor. In the case that the signal intensity of the message is greater than the third threshold or within the third predetermined range for the predetermined period, the corresponding signal intensity of the message is strong; while in the case that the signal intensity of the message is less than the fourth threshold or within the fourth predetermined range for the predetermined period, the corresponding signal intensity of the message is poor. When the signal intensity of the message is strong, the intelligent electric apparatus is turned on; while when the signal intensity of the message is poor, the intelligent electric apparatus is turned off.

FIG. 3E shows a circumstance where step S103 includes steps S306 and S307. The order of implementing steps S306 and S307 is not limited to the one shown in FIG. 3E. In addition, in an alternative embodiment, step S103 can include only one of step S306 and step S307.

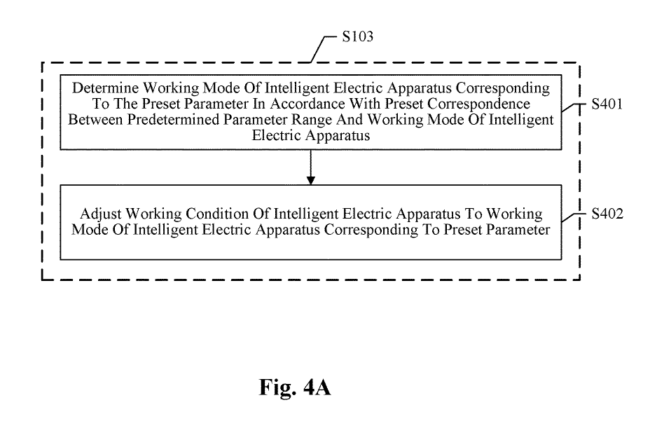

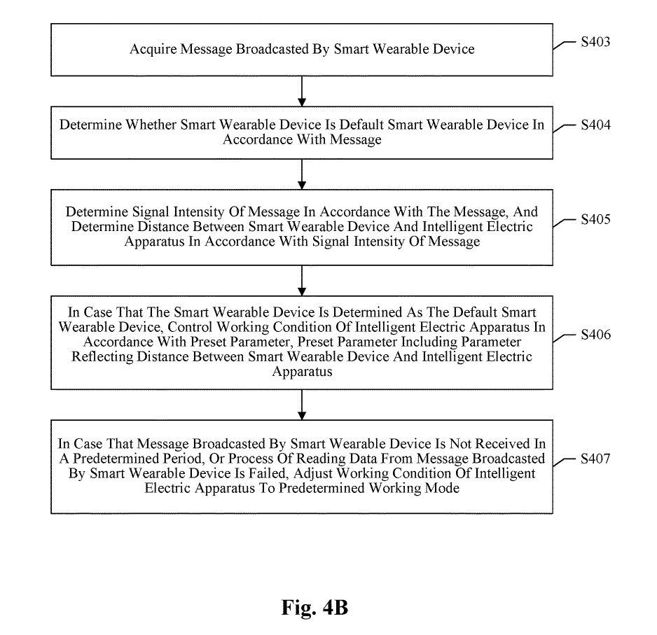

In an embodiment, as shown in FIG. 4A, step S103 can be implemented as steps S401 and S402 as below.

In step S401, a working mode of the intelligent electric apparatus corresponding to the preset parameter is determined in accordance with a preset correspondence between predetermined parameter ranges and working modes of the intelligent electric apparatus.

In step S402, the working condition of the intelligent electric apparatus is adjusted to the working mode of the intelligent electric apparatus corresponding to the preset parameter.

In one embodiment, the intelligent electric apparatus is a smart air conditioner. An operation mode of the smart air conditioner can include: a cooling mode, a heating mode, and a ventilating mode. The correspondence between predetermined parameter ranges and working modes of the intelligent electric apparatus can be set in advance under different operating modes. By way of examples, when the operating mode is the ventilating mode, several distance ranges can be set in advance, like a range from 0 to 3 meters, a range from 3 meters to 5 meters, and a range from 5 meters to 6 meters, and these three ranges can correspond to working modes of low wind speed, medium wind speed, and high wind speed, respectively. Then in the case that the distance between the smart wearable device and the smart air conditioner is 4 meters and the operating mode is the ventilation mode, the working condition of the smart air conditioner can be automatically adjusted to medium wind speed. In the above embodiment, the working condition of the intelligent electric apparatus may be adjusted in accordance with the preset parameter, so as to meet user's requirements.

In an embodiment, as shown in FIG. 4B, the above method may further include steps S403 to S407.

In step S403, a message broadcasted by a smart wearable device is acquired.

In step S404, whether the smart wearable device is a default smart wearable device is determined in accordance with the message.

In step S405, a signal intensity of the message is determined in accordance with the message, and a distance between the smart wearable device and the intelligent electric apparatus is determined in accordance with the signal intensity of the message.

In step S406, in the case that the smart wearable device is determined as the default smart wearable device, a working condition of the intelligent electric apparatus is controlled in accordance with a preset parameter. The preset parameter includes a parameter reflecting the distance between the smart wearable device and the intelligent electric apparatus.

In step S407, in the case that the message broadcasted by the smart wearable device is not received in a predetermined period, or the process of judging whether the smart wearable device is the default smart wearable device in accordance with the message is failed, the working condition of the intelligent electric apparatus is adjusted to a predetermined working mode.

In the case that the intelligent electric apparatus is incapable of receiving the message broadcasted by the smart wearable device or reading data from the message broadcasted by the smart wearable device, or the process of judging whether the smart wearable device is the default smart wearable device in accordance with the message is failed, it determines that the smart wearable device is in a leaving state, an off state, or a failure state. At this time, the intelligent electric apparatus can be adjusted to the predetermined mode.

For example, in the case that the smart wearable device is in the off or failure state, the intelligent electric apparatus is adjusted to a standby sleep mode. In the case that the smart wearable device is in the leaving state, the intelligent electric apparatus is adjusted to an underpowered sleep mode. The sleep mode can include various sub-modes, and a parameter thereof can be set in advance by the user, or can be acquired by learning historical data sent from the smart wearable device.

According to embodiments of the present disclosure, the above method may control the intelligent electric apparatus in a smart manner in accordance with the distance between the smart wearable device and the intelligent electric apparatus, so that it is not necessary for the user to operate the intelligent electric apparatus manually, thereby improving the user's experience.

The above technical solution provided by embodiments of the present disclosure is illustrated with specific embodiments hereinafter.

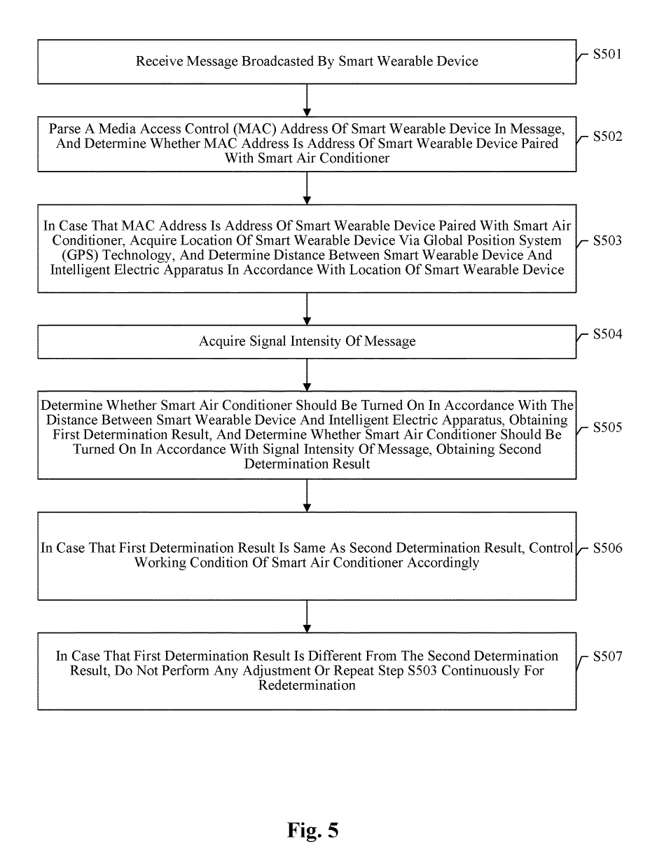

As shown in FIG. 5, in a method of controlling the intelligent electric apparatus provided by embodiments of the present disclosure, the smart wearable device is a smart band, and the intelligent electric apparatus is a smart air conditioner. The smart air conditioner performs the following steps.

In step S501, the smart air conditioner receives a message broadcasted by the smart wearable device.

In step S502, the smart air conditioner parses a media access control (MAC) address of the smart wearable device in the message, and determines whether the MAC address is an address of a smart wearable device paired with the smart air conditioner.

In step S503, in the case that the MAC address is an address of a smart wearable device paired with the smart air conditioner, the smart air conditioner acquires a location of the smart wearable device is acquired via a global position system (GPS) technology, and determines a distance between the smart wearable device and the intelligent electric apparatus in accordance with the location of the smart wearable device.

In step S504, the smart air conditioner acquires a signal intensity of the message.

In step S505, the smart air conditioner determines whether the smart air conditioner should be turned on in accordance with the distance between the smart wearable device and the intelligent electric apparatus, obtaining a first determination result; and the smart air conditioner determines whether the smart air conditioner should be turned on in accordance with the signal intensity of the message, obtaining a second determination result.

In step S506, in the case that the first determination result is same as the second determination result, the working condition of the smart air conditioner is controlled accordingly. The first determination result being same as the second determination result indicates that it is determined that the smart air conditioner should be turned on or off in accordance with both the distance between the smart wearable device and the intelligent electric apparatus and the signal intensity of the message.

In step S507, in the case that the first determination result is different from the second determination result, the smart air conditioner does not perform any adjustment, or repeat step S503 continuously for redetermination. If, after N times (N being greater than or equal to 2) of redeterminations, a result still indicates that the first determination result is different from the second determination result, the smart air conditioner does not perform any adjustment. If, after less than N times of redetermination, a result indicates that the first determination result is same as the second determination result, the working condition of the smart air conditioner is controlled in accordance with this result.

In an embodiment, the intelligent electric apparatus can include: a smart air conditioner, a smart television, an intelligent lamp, a smart tablet, an intelligent electric water heater, and the like.

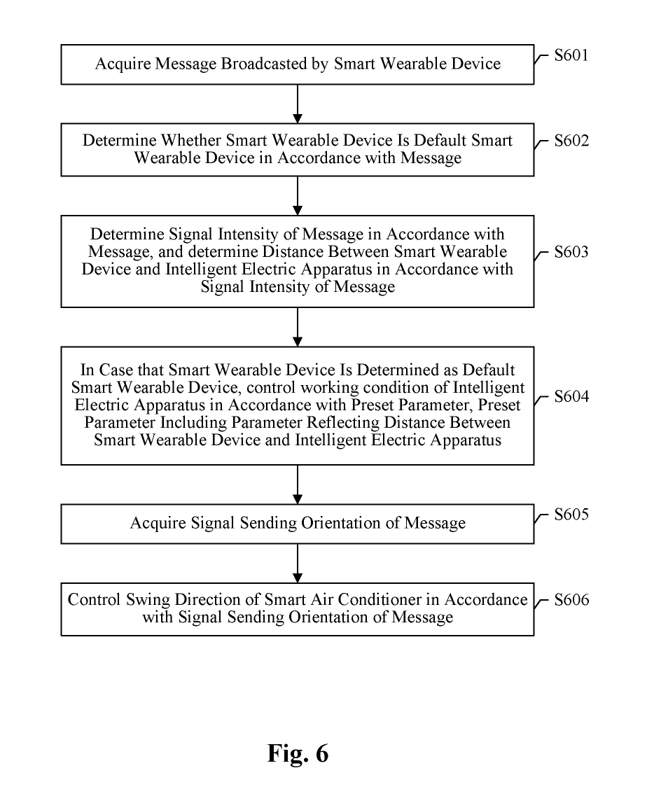

In an embodiment, in the case that the intelligent electric apparatus is the smart air conditioner, as shown in FIG. 6, the method may include the following steps S601 to S606.

In step S601, a message broadcasted by a smart wearable device is acquired.

In step S602, whether the smart wearable device is a default smart wearable device is determined in accordance with the message.

In step S603, a signal intensity of the message is determined in accordance with the message, and a distance between the smart wearable device and the intelligent electric apparatus is determined in accordance with the signal intensity of the message.

In step S604, in the case that the smart wearable device is determined as the default smart wearable device, a working condition of the intelligent electric apparatus is controlled in accordance with a preset parameter. The preset parameter includes a parameter reflecting the distance between the smart wearable device and the intelligent electric apparatus.

In step S605, a signal sending orientation of the message is acquired.

In step S606, a swing direction of the smart air conditioner is controlled in accordance with the signal sending orientation of the message.

In the present embodiment, a message sending point, i.e., a location of the smart wearable device, can be determined in accordance with the signal sending orientation of the message, so as to determine an orientation of the user, thereby controlling the swing direction of the smart air conditioner. For example, when the user is at a certain position to the right of the smart air conditioner, the smart air conditioner can be controlled to blow towards its left side, so as to prevent an air outlet from facing the user directly.

The following device embodiments of the present disclosure may be used to perform the method embodiments of the present disclosure.

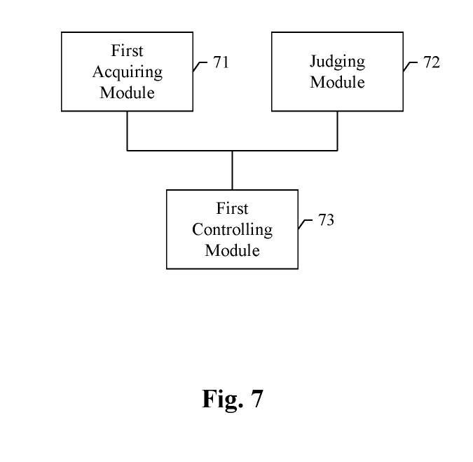

FIG. 7 is a block diagram illustrating an intelligent electric apparatus according to an illustrative embodiment. The intelligent electric apparatus can be implemented as all or part of an electronic device through software, hardware or a combination thereof. As shown in FIG. 7, the intelligent electric apparatus can include: a first acquiring module 71, configured to acquire a message broadcasted by a smart wearable device; a judging module 72, configured to judge whether the smart wearable device is a default smart wearable device in accordance with the message; and a first controlling module 73, configured to control a working condition of the intelligent electric apparatus in accordance with a preset parameter in the case that the smart wearable device is determined as the default smart wearable device, the preset parameter including a parameter reflecting a distance between the smart wearable device and the intelligent electric apparatus.

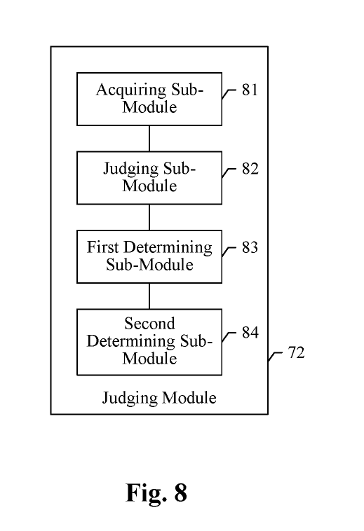

In an embodiment, as shown in FIG. 8, the judging module 72 can include: an acquiring sub-module 81, configured to acquire an identification of the smart wearable device from the message; a judging sub-module 82, configured to judge whether the identification is a first device identification preset in a terminal for controlling the intelligent electric apparatus, or judge whether the identification is a second device identification paired with the intelligent electric apparatus, or judge whether the identification is both of the first device identification and the second device identification; a first determining sub-module 83, configured to determine the smart wearable device is the default smart wearable device if a judgment result is positive; and a second determining sub-module 84, configured to determine the smart wearable device is not the default smart wearable device if a judgment result is negative.

In an embodiment, the identification of the smart wearable device can include a hardware address of the smart wearable device or a unique name of the smart wearable device.

In an embodiment, the preset parameter can include one or more of the distance between the smart wearable device and the intelligent electric apparatus and a signal intensity of the message.

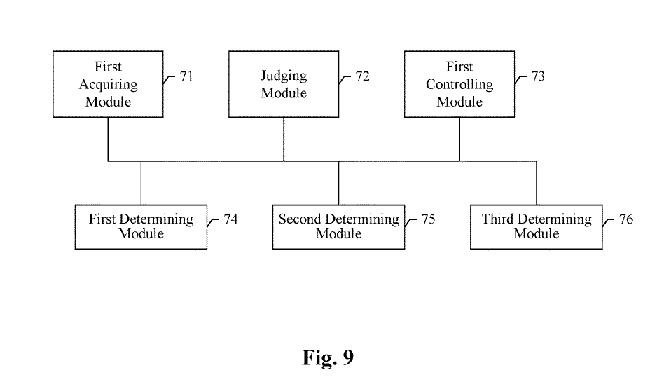

In an embodiment, as shown in FIG. 9, the above device can further include any one or more of the following modules: a first determining module 74, configured to acquire a location of the smart wearable device via a global position system (GPS) technology, and determine the distance between the smart wearable device and the intelligent electric apparatus in accordance with the location of the smart wearable device; a second determining module 75, configured to determine the distance between the smart wearable device and the intelligent electric apparatus via an infrared detection technology; and a third determining module 76, configured to determine the signal intensity of the message in accordance with the message.

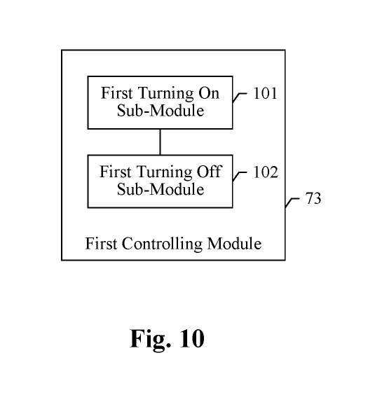

In an embodiment, as shown in FIG. 10, in the case that the preset parameter includes the distance between the smart wearable device and the intelligent electric apparatus, the first controlling module 73 can include: a first turning on sub-module 101, configured to turn on the intelligent electric apparatus in the case that the distance is less than a first threshold or within a first predetermined range for a predetermined period; and/or a first turning off sub-module 102, configured to turn off the intelligent electric apparatus in the case that the distance is greater than a second threshold or within a second predetermined range for the predetermined period, in which the first threshold is less than or equal to the second threshold, and a maximal value of the first predetermined range is less than or equal to a minimal value of the second predetermined range.

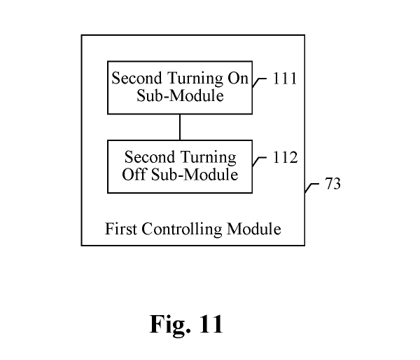

In an embodiment, as shown in FIG. 11, in the case that the preset parameter includes the signal intensity of the message, the first controlling module 73 can further include: a second turning on sub-module 111, configured to turn on the intelligent electric apparatus in the case that the signal intensity is greater than a third threshold or within a third predetermined range for a predetermined period; and/or a second turning off sub-module 112, configured to turn off the intelligent electric apparatus in the case that the signal intensity is less than a fourth threshold or within a fourth predetermined range for the predetermined period, in which the third threshold is greater than or equal to the fourth threshold, and a minimal value of the third predetermined range is greater than or equal to a maximal value of the fourth predetermined range.

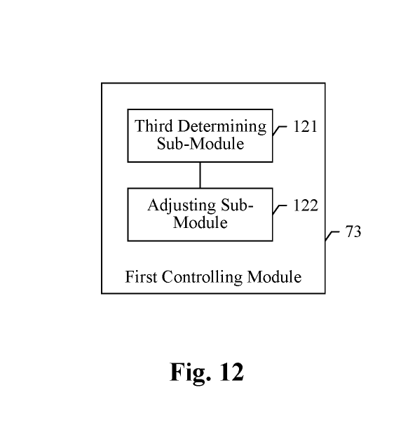

In an embodiment, as shown in FIG. 12, the first controlling module 73 can include: a third determining sub-module 121, configured to determine a working mode of the intelligent electric apparatus corresponding to the preset parameter in accordance with a preset correspondence between predetermined parameter ranges and working modes of the intelligent electric apparatus; and an adjusting sub-module 122, configured to adjust the working condition of the intelligent electric apparatus to the working mode of the intelligent electric apparatus corresponding to the preset parameter.

In an embodiment, the intelligent electric apparatus can include: a smart air conditioner, a smart television, an intelligent lamp, a smart tablet, and an intelligent electric water heater.

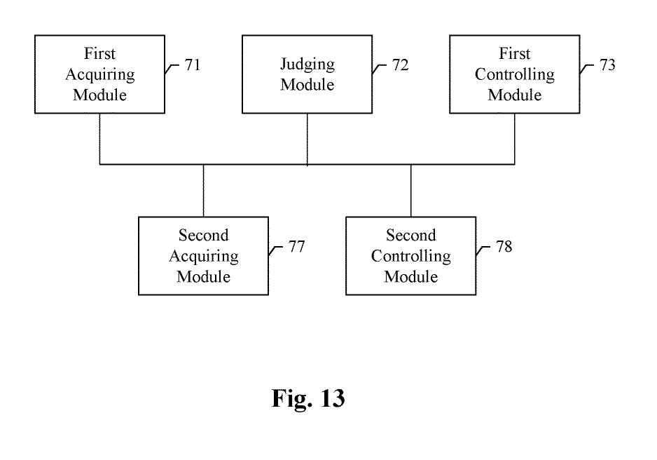

In an embodiment, in the case that the intelligent electric apparatus is the smart air conditioner, as shown in FIG. 13, the above device can further include: a second acquiring module 77, configured to acquire a signal sending orientation of the message; and a second controlling module 78, configured to control a swing direction of the smart air conditioner in accordance with the signal sending orientation of the message.

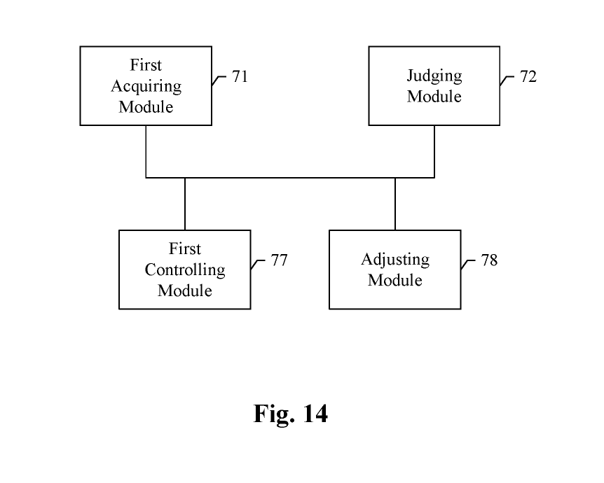

In an embodiment, as shown in FIG. 14, the above device can further include: an adjusting module 79, configured to adjust the working condition of the intelligent electric apparatus to a predetermined working mode, in the case that the message broadcasted by the smart wearable device is not received in a predetermined period or the process of judging whether the smart wearable device is the default smart wearable device in accordance with the message is failed.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of submodules.

According to a third aspect of embodiments of the present disclosure, there is provided an intelligent electric apparatus, including: a processor; and a memory for storing instructions executable by the processor. The processor is configured to, when executing the instructions stored in the memory, acquire a message broadcasted by a smart wearable device; judge whether the smart wearable device is a default smart wearable device in accordance with the message; and control a working condition of the intelligent electric apparatus in accordance with a preset parameter if the smart wearable device is determined as the default smart wearable device, the preset parameter including a parameter reflecting a distance between the smart wearable device and the intelligent electric apparatus.

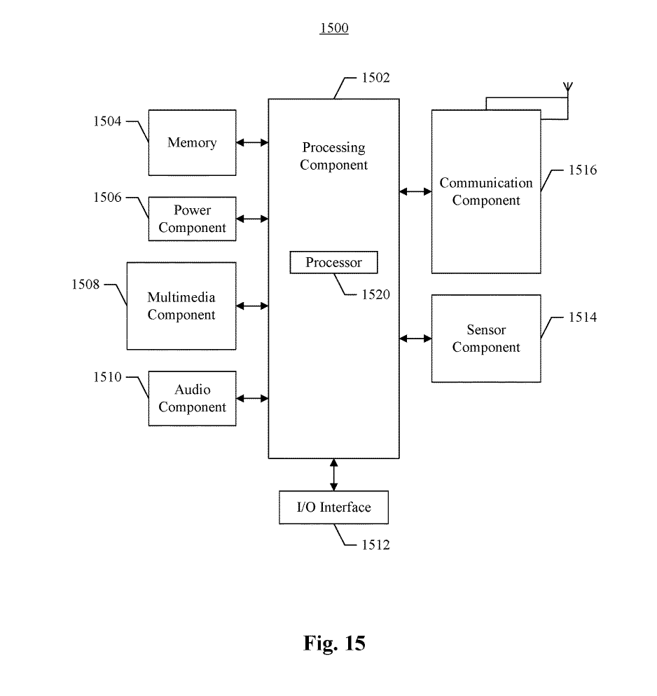

FIG. 15 is a block diagram illustrating a device 1500 as an intelligent electric apparatus according to an illustrative embodiment. For example, the device 1500 may be a mobile phone, a computer, a digital broadcast terminal, a message receiving and sending device, a gaming console, a tablet device, a medical device, exercise equipment, a personal digital assistant, and the like.

The device 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the device 1500, such as the operations associated with display, telephone calls, data communications, camera operations, and recording operations. The processing component 1502 may include one or more processors 1220 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the device 1500. Examples of such data include instructions for any applications or methods operated on the device 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the device 1500. The power component 1506 may include a power management system, one or more power sources, and any other components associated with the generation, management, and distribution of power in the device 1500.

The multimedia component 1508 includes a screen providing an output interface between the device 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the device 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (“MIC”) configured to receive an external audio signal when the device 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the device 1500. For instance, the sensor component 1514 may detect an open/closed status of the device 1500, relative positioning of components, e.g., the display and the keypad, of the device 1500, a change in position of the device 1500 or a component of the device 1500, a presence or absence of user contact with the device 1500, an orientation or an acceleration/deceleration of the device 1500, and a change in temperature of the device 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the device 1500 and other devices. The device 1500 can access a wireless network based on a communication standard, such as WiFi, 2G or 3G or a combination thereof. In one illustrative embodiment, the communication component 1516 receives a broadcast signal or broadcast associated information from an external broadcast management system via a broadcast channel. In one illustrative embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In illustrative embodiments, the device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an embodiment, there is also provided a non-transitory computer-readable storage medium having stored therein instructions that, when executed by a processor of the device 1500, cause the above device to perform the above described methods.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method of controlling an intelligent electric apparatus, comprising:
acquiring a message broadcasted by a smart wearable device;
judging whether the smart wearable device is a default smart wearable device in accordance with the message; and
controlling a working condition of the intelligent electric apparatus in accordance with a preset parameter if the smart wearable device is determined as the default smart wearable device, the preset parameter comprising a parameter reflecting a distance between the smart wearable device and the intelligent electric apparatus.

2. The method according to claim 1, wherein judging whether the smart wearable device is the default smart wearable device in accordance with the message comprises:
acquiring an identification of the smart wearable device from the message;
judging whether the identification is at least one of a first device identification preset in a terminal for controlling the intelligent electric apparatus and a second device identification paired with the intelligent electric apparatus;
determining the smart wearable device is the default smart wearable device if a judgment result is positive; and
determining the smart wearable device is not the default smart wearable device if a judgment result is negative.

3. The method according to claim 2, wherein the identification of the smart wearable device comprises at least one of a hardware address of the smart wearable device or a unique name of the smart wearable device.

4. The method according to claim 1, wherein the preset parameter comprises at least one of the distance between the smart wearable device and the intelligent electric apparatus or a signal intensity of the message.

5. The method according to claim 4, wherein prior to controlling the working condition of the intelligent electric apparatus in accordance with the preset parameter, the method further comprises at least one of following operations of:
acquiring a location of the smart wearable device via a global position system (GPS) technology, and determining the distance between the smart wearable device and the intelligent electric apparatus in accordance with the location of the smart wearable device;
determining the distance between the smart wearable device and the intelligent electric apparatus via an infrared detection technology; or
determining the signal intensity of the message in accordance with the message, and determining the distance between the smart wearable device and the intelligent electric apparatus in accordance with the signal intensity of the message.

6. The method according to claim 4, wherein if the preset parameter comprises the distance between the smart wearable device and the intelligent electric apparatus, controlling the working condition of the intelligent electric apparatus in accordance with the preset parameter comprises at least one of:
turning on the intelligent electric apparatus if the distance is less than a first threshold or within a first predetermined range for a predetermined period; or
turning off the intelligent electric apparatus if the distance is greater than a second threshold or within a second predetermined range for the predetermined period,
wherein the first threshold is less than or equal to the second threshold, and a maximal value of the first predetermined range is less than or equal to a minimal value of the second predetermined range.

7. The method according to claim 4, wherein if the preset parameter comprises the signal intensity of the message, controlling the operating mode of the intelligent electric apparatus in accordance with the preset parameter comprises at least one of:
turning on the intelligent electric apparatus if the signal intensity is greater than a third threshold or within a third predetermined range for a predetermined period; or
turning off the intelligent electric apparatus if the signal intensity is less than a fourth threshold or within a fourth predetermined range for the predetermined period,
wherein the third threshold is greater than or equal to the fourth threshold, and a minimal value of the third predetermined range is greater than or equal to a maximal value of the fourth predetermined range.

8. The method according to claim 4, wherein controlling the operating mode of the intelligent electric apparatus in accordance with the preset parameter comprises:
determining a working mode of the intelligent electric apparatus corresponding to the preset parameter in accordance with a preset correspondence between predetermined parameter ranges and working modes of the intelligent electric apparatus; and
adjusting the working condition of the intelligent electric apparatus to the working mode of the intelligent electric apparatus corresponding to the preset parameter.

9. The method according to claim 1, further comprising:
adjusting the working condition of the intelligent electric apparatus to a predetermined working mode, if the message broadcasted by the smart wearable device is not received in a predetermined period or the process of judging whether the smart wearable device is the default smart wearable device in accordance with the message is failed.

10. The method according to claim 1, wherein if the intelligent electric apparatus is a smart air conditioner, the method further comprises:
acquiring a signal sending orientation of the message; and
controlling a swing direction of the smart air conditioner in accordance with the signal sending orientation of the message.

11. An intelligent electric apparatus, comprising:
a processor; and
a memory for storing instructions executable by the processor,
wherein the processor is configured to, when executing the instructions stored in the memory:
acquire a message broadcasted by a smart wearable device;
judge whether the smart wearable device is a default smart wearable device in accordance with the message; and
control a working condition of the intelligent electric apparatus in accordance with a preset parameter if the smart wearable device is determined as the default smart wearable device, the preset parameter including a parameter reflecting a distance between the smart wearable device and the intelligent electric apparatus.

12. The apparatus according to claim 11, wherein the processor is configured to judge whether the smart wearable device is the default smart wearable device in accordance with the message by steps of:
acquiring an identification of the smart wearable device from the message;
judging whether the identification is at least one of a first device identification preset in a terminal for controlling the intelligent electric apparatus and a second device identification paired with the intelligent electric apparatus;
determining the smart wearable device is the default smart wearable device if a judgment result is positive; and
determining the smart wearable device is not the default smart wearable device if a judgment result is negative.

13. The apparatus according to claim 12, wherein the identification of the smart wearable device comprises a hardware address of the smart wearable device or a unique name of the smart wearable device.

14. The apparatus according to claim 13, wherein the preset parameter comprises at least one of the distance between the smart wearable device and the intelligent electric apparatus or a signal intensity of the message.

15. The apparatus according to claim 14, wherein if the preset parameter comprises the distance between the smart wearable device and the intelligent electric apparatus, the processor is configured to control the working condition of the intelligent electric apparatus in accordance with the preset parameter by at least one step of:
turning on the intelligent electric apparatus if the distance is less than a first threshold or within a first predetermined range for a predetermined period; or
turning off the intelligent electric apparatus if the distance is greater than a second threshold or within a second predetermined range for the predetermined period,
wherein the first threshold is less than or equal to the second threshold, and a maximal value of the first predetermined range is less than or equal to a minimal value of the second predetermined range.

16. The apparatus according to claim 14, wherein if the preset parameter comprises the signal intensity of the message, the processor is configured to control the operating mode of the intelligent electric apparatus in accordance with the preset parameter by at least one step of:
turning on the intelligent electric apparatus if the signal intensity is greater than a third threshold or within a third predetermined range for a predetermined period; or
turning off the intelligent electric apparatus if the signal intensity is less than a fourth threshold or within a fourth predetermined range for the predetermined period,
wherein the third threshold is greater than or equal to the fourth threshold, and a minimal value of the third predetermined range is greater than or equal to a maximal value of the fourth predetermined range.

17. The apparatus according to claim 11, wherein the processor is configured to control the operating mode of the intelligent electric apparatus in accordance with the preset parameter by steps of:
determining a working mode of the intelligent electric apparatus corresponding to the preset parameter in accordance with a preset correspondence between predetermined parameter ranges and working modes of the intelligent electric apparatus; and
adjusting the working condition of the intelligent electric apparatus to the working mode of the intelligent electric apparatus corresponding to the preset parameter.

18. The apparatus according to claim 11, the processor is further configured to:
adjust the operating mode of the intelligent electric apparatus to a predetermined operating mode, if the message broadcasted by the smart wearable device is not received in a predetermined period or it is failed to judge whether the smart wearable device is the default smart wearable device in accordance with the message.

19. The apparatus according to claim 11, wherein if the intelligent electric apparatus is a smart air conditioner, the processor is further configured to:
acquire a signal sending orientation of the message; and
control a swing direction of the smart air conditioner in accordance with the signal sending orientation of the message.

20. A non-transitory computer-readable storage medium having stored therein instructions that, when executed by a processor of a device, cause the device to perform a method of controlling an intelligent electric apparatus, the method comprising:
acquiring a message broadcasted by a smart wearable device;
judging whether the smart wearable device is a default smart wearable device in accordance with the message; and
controlling a working condition of the intelligent electric apparatus in accordance with a preset parameter if the smart wearable device is determined as the default smart wearable device, the preset parameter comprising a parameter reflecting a distance between the smart wearable device and the intelligent electric apparatus.
